(19) United States
(12) Patent Application Publication
(10) Pub. No.: US 2014/0181880 A1
(43) Pub. Date: Jun. 26, 2014

(54) BROADCASTING SYSTEM AND METHOD FOR MULTIMEDIA BITSTREAM

(71) Applicant: Wistron Corporation, New Taipei City (TW)

(72) Inventor: Feng-Yuan Chen, New Taipei City (TW)

(73) Assignee: Wistron Corporation, New Taipei City (TW)

(21) Appl. No.: 14/028,576

(22) Filed: Sep. 17, 2013

(30) Foreign Application Priority Data
Dec. 20, 2012 (TW) 101148589

(51) Int. Cl. H04N 21/2385

(52) U.S. Cl. CPC H04N 21/2385
USPC 725/110

(57) ABSTRACT

A broadcasting system and its associated broadcasting method for multimedia bitstream are provided. The broadcasting system includes a wireless access point, a broadcasting device and a source device. The broadcasting method includes the following steps. A wireless network is provided by the wireless access point. A multimedia bitstream is provided by the source device. A broadcasting command is generated by the source device according to a trigger signal. The broadcasting command is transmitted to the broadcasting device by the source device via the wireless network. A direct communication link is created between the source device and the broadcasting device. In addition, the multimedia bitstream is transmitted to the broadcasting device by the source device via the direct communication link.

This application claims the benefit of Taiwan application Serial No. 101148589, filed Dec. 20, 2012, the subject matter of which is incorporated herein by reference.

### BACKGROUND OF THE INVENTION

1. Field of the Invention

The invention relates in general to a broadcasting system and its associated broadcasting method for multimedia bitstream, and more particularly to a broadcasting system with direct communication function and its associated broadcasting method for multimedia bitstream.

2. Description of the Related Art

The popularity of mobile device gradually boosts the need for the wireless LAN (hereinafter, WLAN). Many households and offices are equipped with a wireless access point (hereinafter, AP) which is also referred as a wireless router. The wireless access point provides log-on and access of wireless network to portable devices such as notebook, smart phone or tablet computer.

The wireless access point can activate a bandwidth management function, and directly assign the priority of network service and bandwidth. However, if the number of portable devices sharing the same wireless network increases, the bandwidth of wireless network that can be assigned to each portable device will be restricted.

Referring to FIG. 1, a schematic diagram of providing wireless network function via a wireless access point according to the prior art is shown. As indicated in FIG. 1, the wireless access point 13 is connected to the cabled network 11 via a cable. The wireless access point 14 provides a wireless network to portable devices A181, B182, and C183.

If the wireless access point 13 only provides a wireless network 10 to the portable device A181, the portable device B 182, and the portable device C183, and these portable devices use the wireless network for simple functions such as browsing webpages and e-mailing. Under such circumstances, the bandwidth of the wireless network 10 is sufficient for providing smooth operation to the portable devices.

However, if the wireless network 10 further needs to provide the function of transmitting a large volume of data package, transmission congestion may easily occur to the wireless network 10.

FIG. 1 further illustrates a source device 17 and a broadcasting device 15 which mutually transmit multimedia bitstream via the wireless network. For example, the source device 17 can be a PC, and the broadcasting device 15 can be a display with access of wireless network.

Suppose many films are stored in the source device 17 and each film corresponds to a multimedia bitstream. When the user would like to view one of the films, the user first needs to set the source device for transmitting the multimedia bitstream to the broadcasting device 15 via the wireless network 10. After receiving the multimedia bitstream, the broadcasting device 15 then broadcasts the film.

However, when the transmission/reception of multimedia bitstream occupies a larger bandwidth, the bandwidth of the wireless network 10 used by the portable device A 181, the portable device B 182, and the portable device C183 may be restricted. In the diagram, a larger and wider arrow indicates a wider bandwidth is required for the transmission of multimedia bitstream.

For example, when the portable device is using a number of applications, such as the file transfer protocols (hereinafter, FTP) and the voice over internet protocol (hereinafter, VoIP), the portable device itself needs a stable bandwidth. If multimedia bitstream needs to be transmitted between the source device 17 and the broadcasting device 15, the applications will have longer waiting time or may even be paused.

In other words, given that the bandwidth of the wireless network 10 provided by the wireless access point 13 is limited, the above method of transmitting multimedia bitstream via the wireless network 10 may easily affect the operation of other portable devices using the same wireless network 10.

### SUMMARY OF THE INVENTION

According to one embodiment of the present invention, a multimedia broadcasting system is provided. The multimedia broadcasting system includes a wireless access point, a broadcasting device, and a source device. The wireless access point provides a wireless network. The broadcasting device is in communication with the wireless network. The source device is in communication with to the wireless network for providing a multimedia bitstream. The source device generates a broadcasting command according to a trigger signal. After the broadcasting command is transmitted to the broadcasting device via the wireless network, a direct communication link is created between the source device and the broadcasting device. In addition, the multimedia bitstream is transmitted to the broadcasting device by the source device via the direct communication link.

According to another embodiment of the present invention, a multimedia broadcasting method used between a wireless access point, a broadcasting device and a source device is provided. The broadcasting method includes the following steps. A wireless network is provided by the wireless access point. A multimedia bitstream is provided by the source device. A broadcasting command is generated by the source device according to a trigger signal. The broadcasting command is transmitted to the broadcasting device by the source device via the wireless network. A direct communication link is created between the source device and the broadcasting device. In addition, the multimedia bitstream is transmitted to the broadcasting device by the source device via the direct communication link.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 (prior art) shows a schematic diagram of providing wireless network function via a wireless access point according to the prior art;

FIG. 2 shows a schematic diagram of a multimedia broadcasting system according to an embodiment of the invention;

FIGS. 3A and 3B show a flowchart of a broadcasting method used between a source device and a broadcasting device according to an embodiment of the invention;

FIG. 4 shows a schematic diagram of a multimedia broadcasting system according to an embodiment of the invention;

FIGS. 5A and 5B show multimedia broadcasting method implemented by using a source device, a wireless access point, and a broadcasting device according to an embodiment of the invention; and

FIGS. 6A and 6B show schematic diagrams of control information between a source device, a wireless access point and a broadcasting device and multimedia bitstream transmission process in a multimedia broadcasting system according to an embodiment of the invention.

### DETAILED DESCRIPTION OF THE INVENTION

When multimedia information is transmitted via a wireless network, a larger bandwidth of the wireless network is required. Therefore, the transmission of multimedia information via a wireless access point not only affects the Internet connection quality of other portable devices but also makes the transmission of multimedia bitstream become intermittent. With respect to the request for transmitting multimedia bitstream, a direct transmission path between the source device and the broadcasting device is provided.

Referring to FIG. 2, a schematic diagram of a multimedia broadcasting system according to an embodiment of the invention is shown.

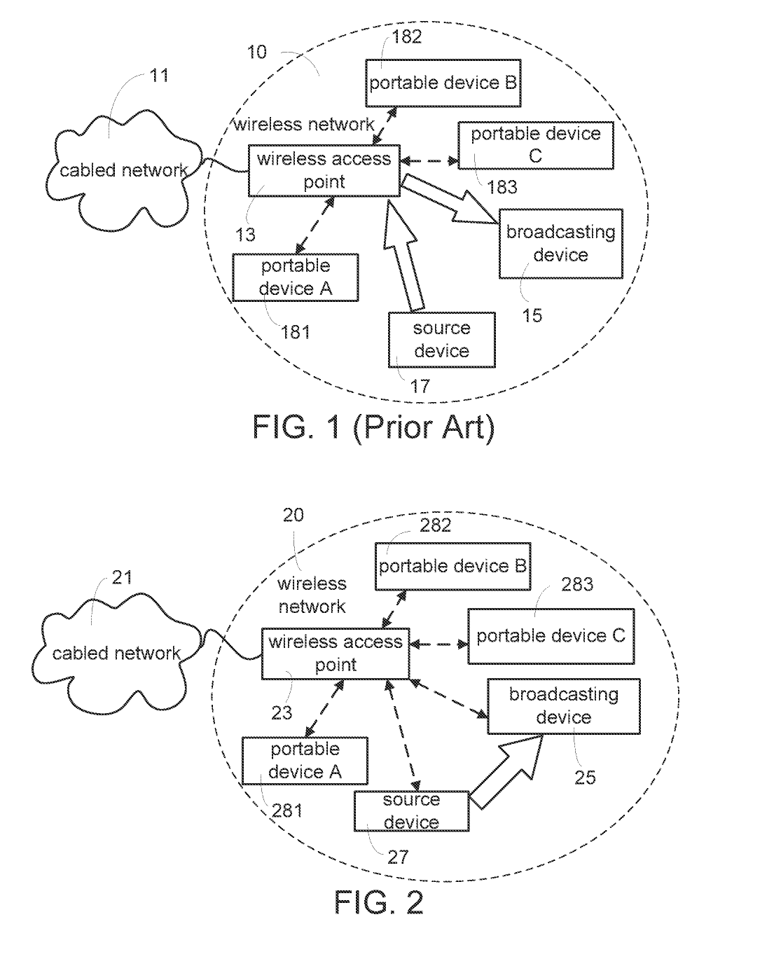

The hardware architecture of FIG. 2 is similar to that of FIG. 1. The multimedia broadcasting system includes a wireless access point 23, a source device 27 and a broadcasting device 25. A portable device A 281, a portable device B 282, and a portable device C 283 share and access to the wireless network 20 provided by the wireless access point 23.

When the source device 27 of the invention transmits a multimedia bitstream to the broadcasting device 25, the multimedia bitstream is not transmitted via the wireless network 20 provided by the wireless access point 23. In the present invention, data transmission between the source device 27 and the broadcasting device 25 is divided into two types, namely, the information associated with control procedure and the multimedia bitstream.

The source device 27 transmits the information associated with control procedure to the broadcasting device 25 via the wireless access point 23. As indicated in FIG. 2, one dotted bi-directional arrow is between the source device 27 and the wireless access point 23. Another dotted bi-directional arrow is between the broadcasting device 25 and the wireless access point 23. The bi-directional arrow represents the transmission of information associated with control procedure. Here, the information associated with control procedure includes the identification, and access authentication of the source device 27 and the broadcasting device 25 with respect to the wireless network 20.

On the other hand, the multimedia bitstream having a larger data volume is not transmitted via the wireless access point 23 in the invention. Instead, the source device 27 directly transmits the multimedia bitstream to the broadcasting device 25. Here, a wider arrow sign is used to indicate the flow of multimedia information from the source device 27 to the broadcasting device 25. In practical application, the direct communication link can be based on such as a tunneled direct link setup (hereinafter, TDLS), a Bluetooth communication, or an infrared communication.

It can be seen from the above two arrow directions that the information associated with control procedure is transmitted via the wireless access point 23, that is, an indirect communication link. On the other hand, the source device 27 directly and quickly transmits the multimedia bitstream information to the broadcasting device 25 via a direct communication link.

According to an embodiment of the invention, the multimedia bitstream whose transmission occupying a larger bandwidth is separated from the wireless network 20. Hence, the multimedia bitstream is not transmitted via the wireless network 20 provided by the wireless access point 23. Since the transmission of multimedia bitstream does not occupy the bandwidth of wireless network 20, the transmission quality of the wireless network 20 can thus be improved.

Moreover, the broadcasting system and broadcasting method for multimedia bitstream of the invention can further reduce the control procedure associated with data transmission between the broadcasting device 25 (such as a display) and the source device 27 (such as a PC).

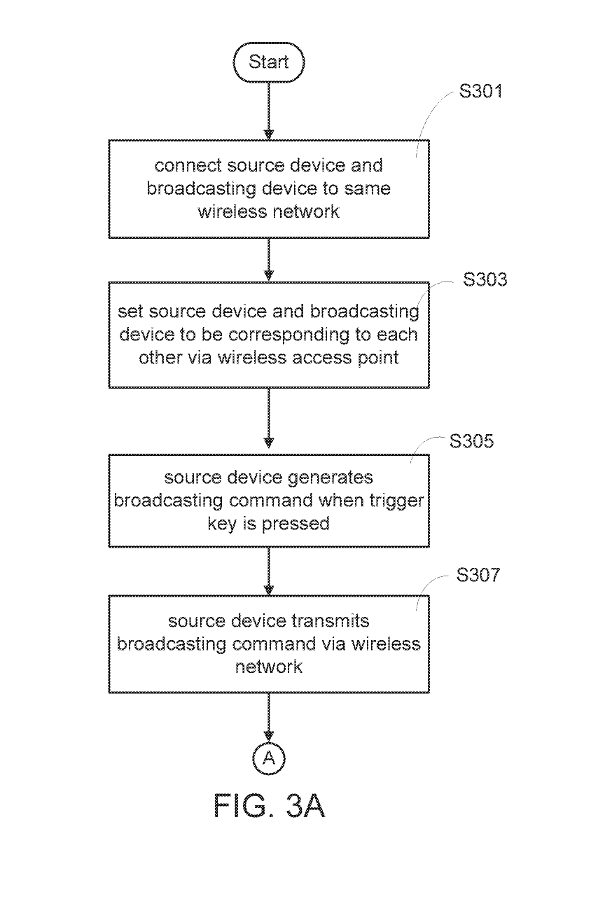

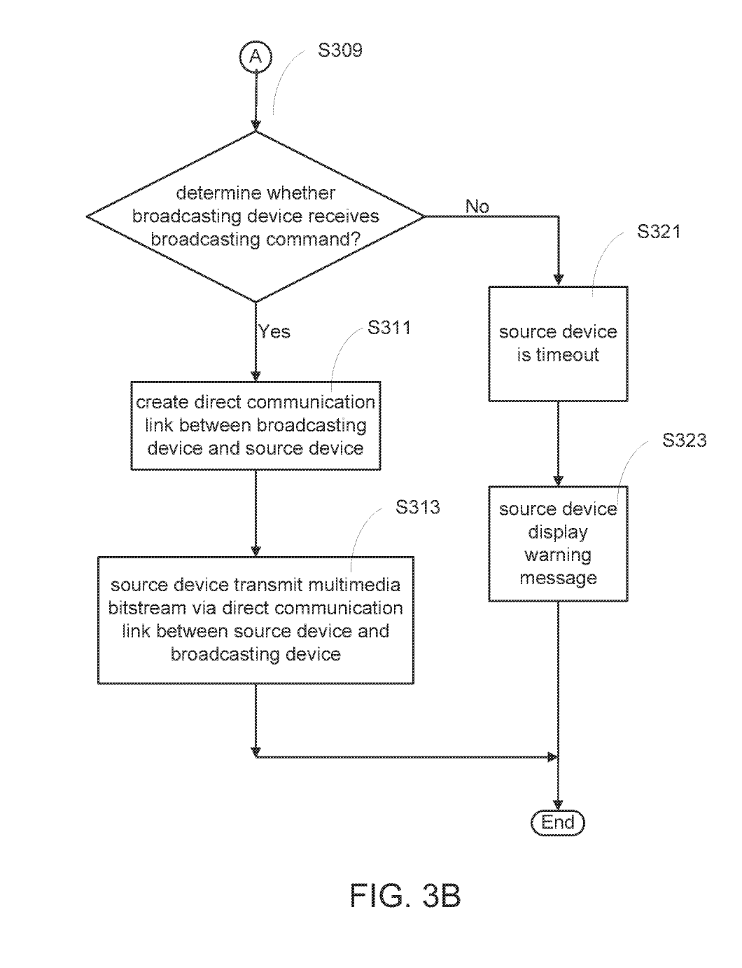

Referring to FIGS. 3A and 3B, a flowchart of a broadcasting method used between a source device and a broadcasting device according to an embodiment of the invention is shown. FIGS. 3A and 3B retain the same relationship architecture between the source device 25, the broadcasting device 27, and the wireless access point 23 as in FIG. 2.

Firstly, the source device 27 and the broadcasting device 25 perform account authentication via the wireless access point. In other words, the users of the source device 27 and the broadcasting device 25 both are identified, approved and authorized by the wireless access point 23 to access the same wireless network 20. For example, the source device 27 and the broadcasting device 25 are devices in the same household or in the same office.

Next, the source device 27 and the broadcasting device 25 are in communication with the wireless network 20 provided by the wireless access point 23 (step S301).

Then, the source device 27 and the broadcasting device 25 can be set to be corresponding to each other via the wireless access point 23 (step S303). In step S303, one or many broadcasting devices 25 (such as a display) can be set to be corresponding to the source device 27 (such as a PC).

For example, there are two displays in the lounge and the bedroom of the user's house respectively. The two displays can share the same wireless network 20, and the user may choose to view a movie with the display in the lounge or the display in the bedroom.

The source device 27 and the broadcasting device 25 do not need to go through the whole identification, approval and authorization procedure every time when the source device 27 or the broadcasting device 25 is switched on. For example, when the user purchases a display having wireless connection to Internet, the user can pre-set (including the information associated with identification, authentication and permission etc.) the wireless network accessible settings to the display, and the corresponding PC.

Similarly, the source device 27, such as a PC, a notebook computer, a tablet PC, or a mobile phone, can store the information associated with account password and authentication of the wireless network, and the information associated with the broadcasting device 25 corresponding to the source device 27 itself. Thus, every time when the source device 27 or the broadcasting device 25 uses the same wireless network 20, neither the source device 27 nor the broadcasting device 25 requires the user to input the information associated with authentication or related settings.

Under normal circumstances, the source device 27 and the broadcasting device 25 can be separately used by the user. For example, the user can use a PC for Internet connection or word processing, and use the broadcasting device 25 for viewing a TV channel. Only when the user wishes to use the broadcasting device 25 to view/listen to the multimedia bitstream stored in the source device 27 will the remaining steps of FIGS. 3A and 3B need to be performed.

In an embodiment of the invention, if the user wishes to view/listen to the multimedia bitstream, the use may press a trigger key of the source device 27. When the source device 27 senses or detects that the trigger key is pressed, the transmission of multimedia bitstream between the source device 27 and the broadcasting device 25 and the broadcasting procedure will be activated.

Meanwhile, the source device 27 generates a broadcasting command when the trigger key is pressed or touched (step S305). The broadcasting command is transmitted to the wireless access point 23 via the wireless network 20 by the source device 27 first. Then, the broadcasting command is further transferred to the broadcasting device via the wireless network 20 by the wireless access point 23 (step S307).

The computer can be used in different places. When the trigger key of the computer is pressed, the computer and the broadcasting device 25 may not be within the coverage of the same wireless network. Therefore, whether the broadcasting device 25 receives the broadcasting command has to be determined (step S309).

If the computer is used outdoors, the computer will not receive any response from the display. Thus, the source device 27 will be timeout while waiting to be connected (step S321). Meanwhile, the source device 27 will display a warning message to remind the user that currently the broadcasting device 25 cannot be used for broadcasting the multimedia bitstream (step S323). That is, if the source device 27 cannot create a direct communication link with the broadcasting device 25, the source device 27 will display the warning message.

Conversely, if both the computer and the display are within the coverage of the same wireless network, the computer will receive a request generated by the display for creating direct communication link.

Next, a direct communication link is created between the broadcasting device 25 and the source device 27 (step S311). After the direct communication link is created, the source device 27 does not use the wireless network 20 provided by the wireless access point 23 to transmit the multimedia bitstream. Instead, the source device 27 transmits the multimedia bitstream via the direct communication link between the source device 27 and the broadcasting device 25 (step S313). After receiving the multimedia bitstream, the broadcasting device 25 starts to broadcast the contents of the multimedia bitstream.

When the multimedia bitstream cannot be completely transmitted to the broadcasting device 25, a warning message can be generated by the source device 27 and/or the broadcasting device 25. For example, the user may go out with the computer before the transmission of the multimedia bitstream is completed.

It should be noted that the broadcasting command transmitted by the source device 27 via the wireless access point 23 may have different varieties. For example, the broadcasting command may represent various functions such as ‘Play’, ‘Stop’, ‘Pause’ or ‘Lock’. The operation corresponding to each broadcasting command can be provided according to the protocols between the source device 27 and the broadcasting device 25. For example, the broadcasting command is defined as follows:

When the broadcasting command is ‘Play’, this implies that the source device 27 starts to transmit the multimedia bitstream to the broadcasting device 25. Meanwhile, the broadcasting device 25 simultaneously broadcasts the contents of the multimedia bitstream.

When the broadcasting command is ‘Stop’, this implies that the source device 27 stops transmitting the multimedia bitstream to the broadcasting device. Meanwhile, the broadcasting device 25 also stops broadcasting the contents of the multimedia bitstream.

When the broadcasting command is ‘Pause’, this implies that the source device 27 continues receiving the multimedia bitstream but pauses broadcasting the contents of the multimedia bitstream.

During the process when the broadcasting device 25 receives and broadcasts the multimedia bitstream, if the user would like to adjust the broadcasting of the multimedia bitstream (such as volume adjustment or fast forwarding), related broadcasting commands still can be transmitted to the wireless access point 23 by the source device 27 via the wireless network 20 first, and then be further transferred to the broadcasting device 25 by the wireless access point 23 via the wireless network 20.

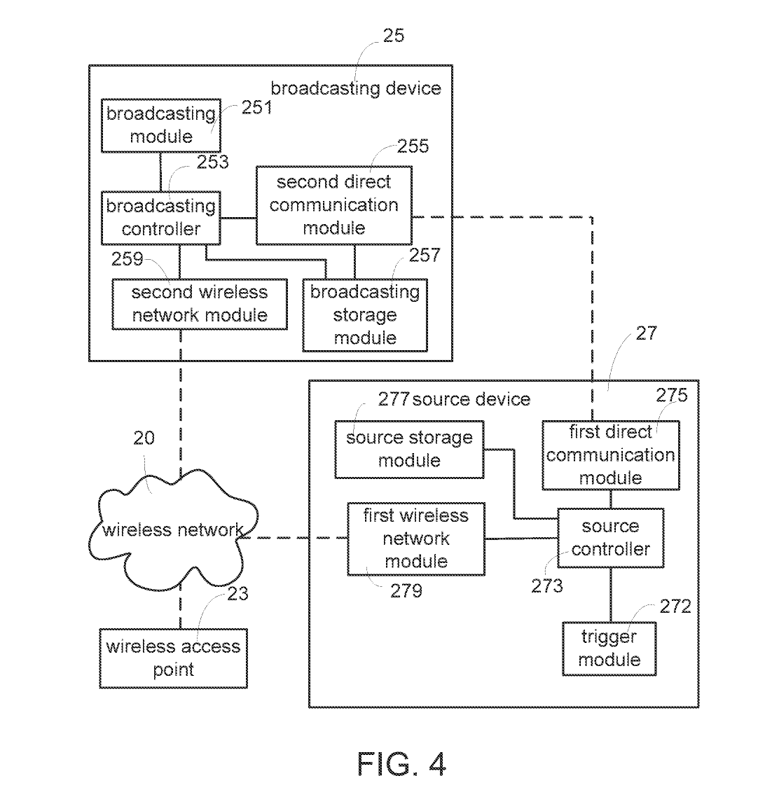

Referring to FIG. 4, a schematic diagram of a multimedia broadcasting system according to an embodiment of the invention is shown. The broadcasting system includes a wireless access point 23, a broadcasting device 25, and a source device 27. The wireless access point 23 provides a wireless network 20 and the wireless access point 23 is in communication with the broadcasting device 25 and the source device 27 via which the wireless network 20.

The wireless access point 23 respectively confirms whether the broadcasting device 25 and the source device 27 have the right to access the wireless network 20 after identifying and/or authorizing the broadcasting device 25 and the source device 27 via the wireless network 20.

The source device 27 includes a source storage module 277, a source controller 273, a first wireless network module 279, a first direct communication module 275, and a trigger module 272. The source storage module 277 provides a plurality of multimedia bitstream, and the user may choose to view/listen to one of the plurality of multimedia bitstream. The source controller 273 is electrically connected to the trigger module 272 and the source storage module 277.

The trigger module 272 generates a trigger signal with a hardware element or a software setting in response to the user's request for broadcasting a multimedia bitstream. In addition, the trigger module 272 transmits the trigger signal to the source controller 273.

For example, the trigger module 272 can be realized by a trigger key on the source device 27. When the user would like the multimedia bitstream to be broadcast, the user can press or touch the trigger key such that the trigger module 272 generates a trigger signal.

Or, the source device 27 provides a software interface. When the user would like to the multimedia bitstream to be broadcast, s/he may switch the operations of the application software to the software interface. For example, a ‘start transmission’ setting can be selected through the software interface so that the trigger module 272 generates a trigger signal.

Next, after receiving the trigger signal, the source controller 273 further generates a broadcasting command to the first wireless network module 279.

The first wireless network module 279 is electrically connected to source controller 273. The first wireless network module 279 is in communication with the wireless access point 23 via the wireless network 20.

The first wireless network module 279 transmits the broadcasting command to the wireless access point 23 via the wireless network 20 first, and then the wireless access point 23 accordingly transfers the broadcasting command to the broadcasting device 25 via the wireless network 20.

Likewise, when the broadcasting device 25 transmits a request for creating direct communication link, the request for creating direct communication link will be transmitted to the wireless access point 23 via the wireless network 20 first. Then, the wireless access point 23 accordingly transfers the request for creating direct communication link via the wireless network 20 to the source device 27. Thus, the first wireless network module 279 will receive the request for creating direct communication link transferred from the wireless access point 23 via the wireless network 20.

In other words, the source device 27 transmits the broadcasting command to the broadcasting device 25. In addition, the request for creating direct communication link is indirectly transmitted to the source device 27 from the broadcasting device 25 via the wireless network 20 and the wireless access point 23.

The first direct communication module 275 is electrically connected to source controller 273. After receiving the request for creating direct communication link, the first wireless network module 279 creates a direct communication link with the second direct communication module 255 of the broadcasting device 25. The first direct communication module 275 transmits the multimedia bitstream to the broadcasting device 25 according to the control of the source controller 273.

The broadcasting device 25 includes a second wireless network module 259, a broadcasting controller 253, a second direct communication module 255, a broadcasting module 251 and a broadcasting storage module 257.

The second wireless network module 259 is in communication with the wireless access point 23 via the wireless network 20. The second wireless network module 259 receives the broadcasting command transferred from the wireless access point 23 via the wireless network 20.

The broadcasting controller 253 is electrically connected to the second wireless network module 259, the second direct communication module 255, the broadcasting module 251 and the broadcasting storage module 257. After the second wireless network module 259 receives the broadcasting command, the broadcasting controller 253 controls the second wireless network module 259 to transmit the request for creating direct communication link.

After a direct communication link between the second direct communication module 255 and the first direct communication module 275 of the source device 27 is created, the second direct communication module 255 receives multimedia bitstream according to the control of the broadcasting controller 253. The multimedia bitstream received from the second direct communication module 255 can be temporarily buffered in the broadcasting storage module 257 instead of being broadcast directly. Or, during the process of receiving the multimedia bitstream, the broadcasting module 251 can broadcast the multimedia bitstream in a simultaneous or real-time manner.

The multimedia bitstream stored in the broadcasting storage module 257 can be broadcast by the broadcasting module 251 according to the control of the broadcasting controller 253. The multimedia bitstream may be a video bitstream or an audio bitstream. The broadcasting module 251 may be a video broadcasting module or an audio broadcasting module.

The broadcasting storage module 257 can further be realized by a non-volatile storage module (such as flash memory) and/or a volatile storage module.

The non-volatile storage device is used for storing information such as programming code or downloaded multimedia bitstream. The volatile storage device is used for temporarily buffering the downloaded multimedia bitstream. After the volatile storage device provides a multimedia bitstream for the broadcasting module 251 to broadcast, the downloaded space of the volatile storage device can be rewritten, and the contents of the temporarily buffered multimedia bitstream are erased when the broadcasting device 25 is power off.

In practical application, it can be assumed that the first wireless network module 279 and the second wireless network module 259 both are a Wi-Fi communication module. In addition, it can be assumed that the first direct communication module 275 and the second direct communication module 255 both are a tunneled direct link setup communication module.

The Wi-Fi communication module can be in communication with the wireless access point 23 via the wireless network 20. On the other hand, the TDLS module is used for transmitting and receiving multimedia bitstream.

In the multimedia broadcasting method of the invention disclosed below, the source device 27 is exemplified by a PC, and the broadcasting device 25 is exemplified by a display. Here, it is assumed that the trigger module is a trigger key. When the user presses or touches the trigger key, this implies that the user would like to the multimedia bitstream starts to be transmitted/broadcast.

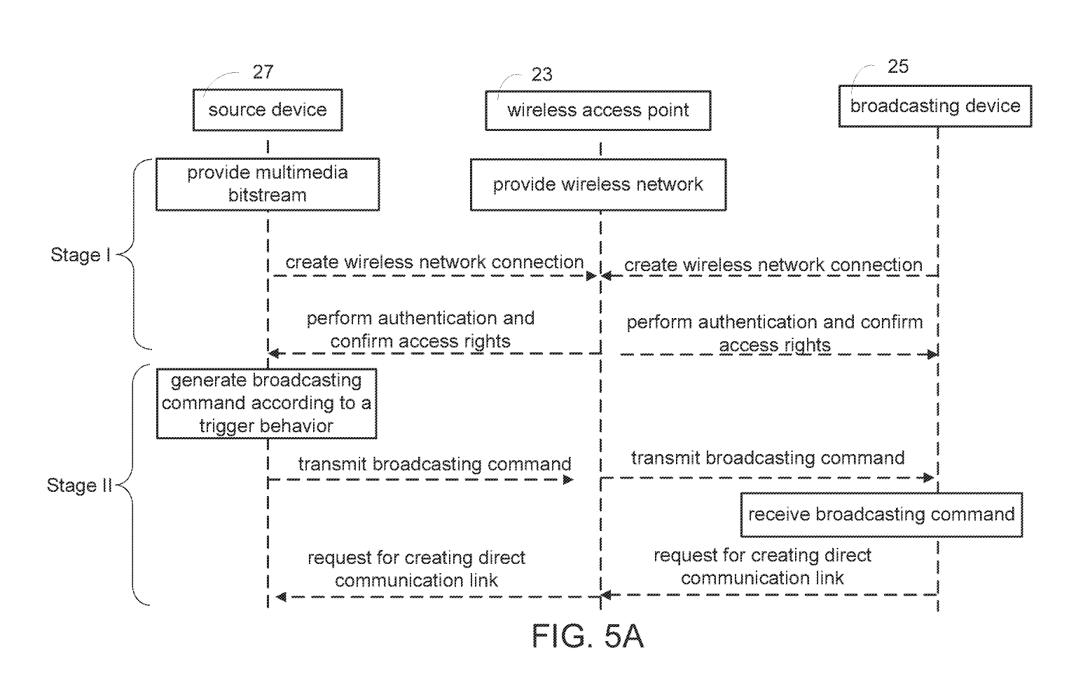

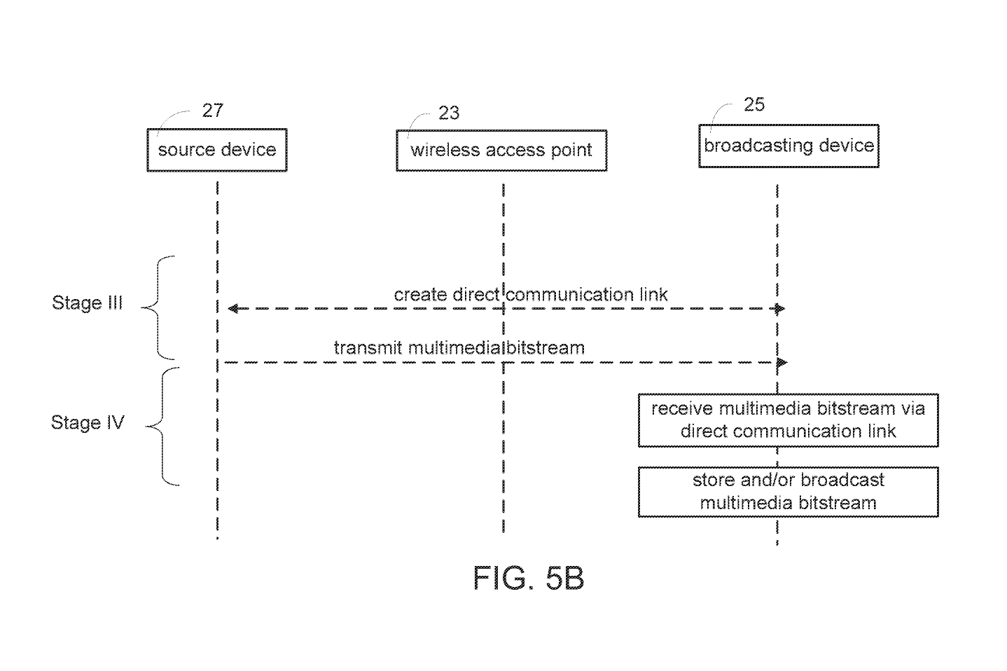

The operations of the devices of the broadcasting system and the interactions between these devices are disclosed below with FIG. 5.

Referring to FIGS. 5A and 5B, a multimedia broadcasting method implemented by using a source device, a wireless access point, and a broadcasting device according to an embodiment of the invention is shown.

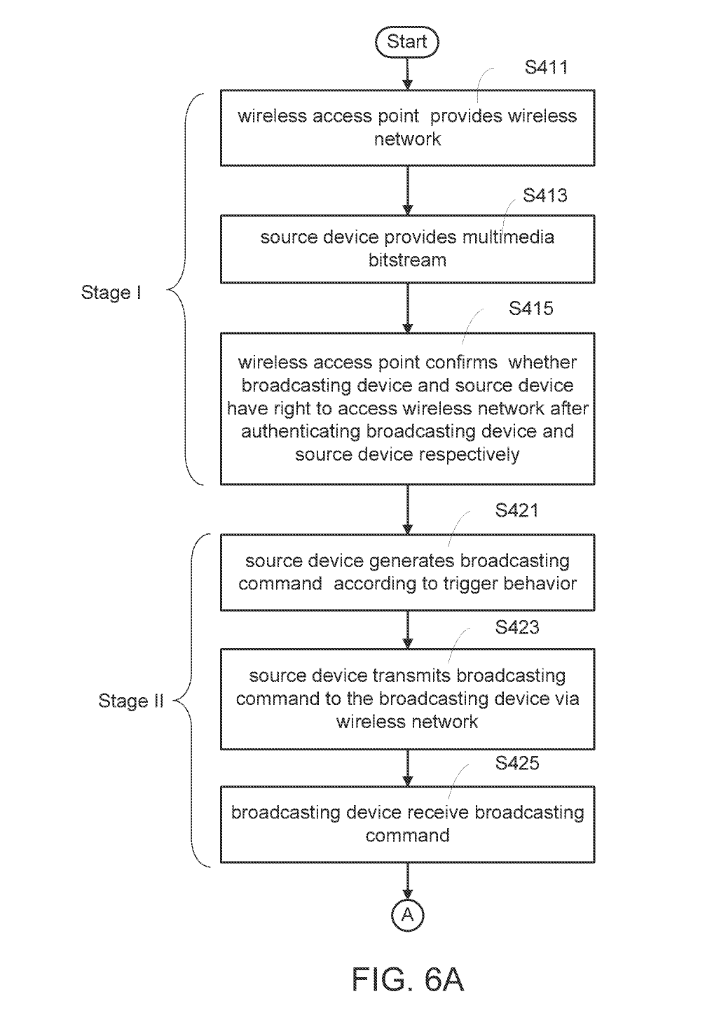

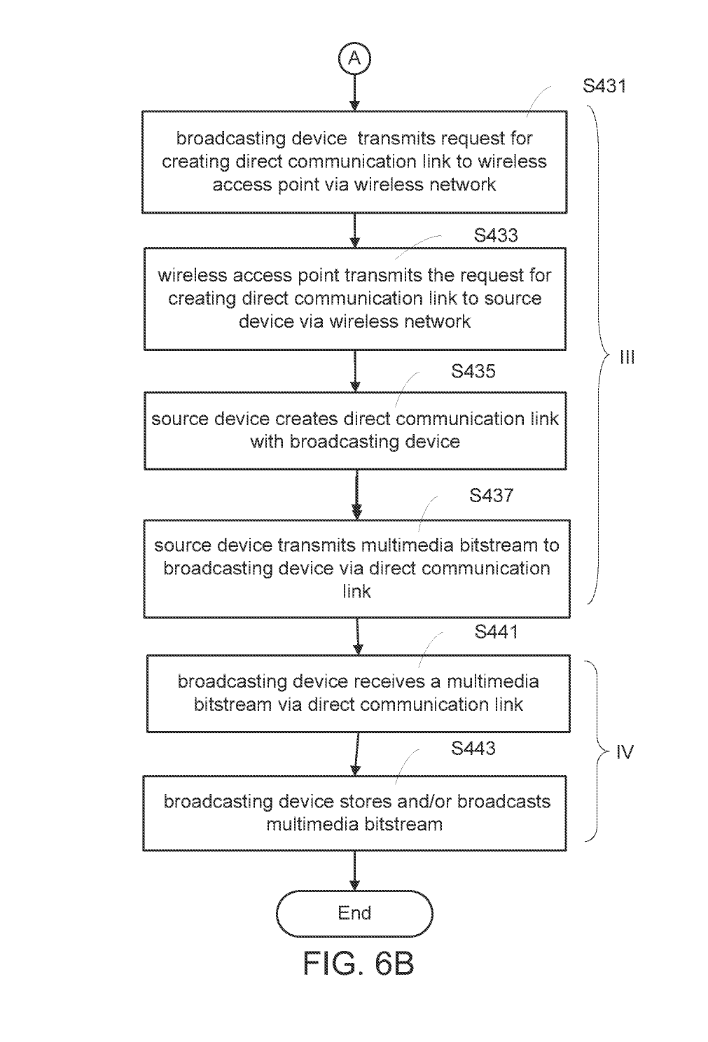

The top to down direction in FIG. 5 denotes time sequence, and the left to right direction corresponds to the operations of the source device 27, the wireless access point 23, and the broadcasting device 25 respectively. Besides, independent operation of each device is denoted by a block, and the arrow signs denote the transmission/reception between devices. Descriptions of the diagram are disclosed with reference to the flowchart of FIG. 6.

Referring to FIGS. 6A and 6B, schematic diagrams of control information between a source device, a wireless access point and a broadcasting device and multimedia bitstream transmission process in a multimedia broadcasting system according to an embodiment of the invention are shown.

The broadcasting method of the invention can be divided into four stages as follows:

In the first stage I, communication is created between the wireless access point 23, the source device 27, and the broadcasting device 25 via the wireless network 20, and the access rights of the source device 27 and the broadcasting device 25 are identified or authenticated. In the second stage II, a broadcasting command is generated and transmitted according to a trigger signal. In the third stage III, a direct communication link is created and the selected multimedia bitstream is transmitted via the direct communication link. In the fourth stage IV, the multimedia bitstream is broadcast by the broadcasting device 25.

In the first stage I, a wireless network 20 is provided by the wireless access point 23 (step S411), and a plurality of multimedia bitstream is provided by the source device 27 (step S413).

Next, communication is created in-between the wireless access point 23 and the source device 27, and in-between the wireless access point 23 and the broadcasting device 25 respectively. Meanwhile, the wireless access point 23 identifies and authenticates the access rights of the source device 27 and the broadcasting device 25 via the wireless network 20.

Only when the source device 27 and the broadcasting device 25 both have the rights to access the wireless network 20 will the source device 27 and the broadcasting device 25 be able to connect to the wireless access point 23. The sequence by which the source device 27 and the broadcasting device 25 create connection with the wireless access point 23 via the wireless network 20 is not subjected to any restrictions.

In the first stage I, identity authentication and confirmation of connection with the wireless access point 23 via the wireless network 20 are performed only once and are not repeated. Thus, the operation of downloading multimedia bitstream in subsequent stages, that is, stages II and III is made easier.

The second stage II is activated according to a trigger signal (step S421). A number of methods for generating the trigger signal are disclosed below:

Firstly, the source device 27 has a hardware element (such as a trigger key or a touch sensing element), and when the user presses the trigger key, this implies that the user would like to start using the source device 27 and the broadcasting device 25 for transmitting/broadcasting the multimedia bitstream. Thus, a trigger signal is transmitted to the source controller 273 when the trigger key is pressed.

Secondly, based on the setting of software, the generation of trigger signal varies with the applications.

For example, each time when the source device 27 starts connecting with the wireless network 20, the trigger module 272 will generate a trigger signal.

Or, the source device 27 provides a software operating interface, and when the user would like to use the broadcasting device 25 to broadcast a multimedia bitstream, the user may select the ‘Start Transmission’ setting through the software operating interface. Meanwhile, the trigger module 272 generates a trigger signal in response to the selected setting.

Another example of software setting is that the source device 27 enables the trigger module 272 to generate a trigger signal at a predetermined time. For example, through the application software, the source device 27 can be pre-set to start transmitting the multimedia bitstream at 10:00 pm. Meanwhile, the trigger module 272 will generate a trigger signal as the timer counts down to the predetermined time.

Next, the source device 27 transmits the broadcasting command via the wireless network 20. The broadcasting command is generated by the source device 27 and is transmitted to the wireless access point 23 via the wireless network 20. Then, the wireless access point 23 transfers the broadcasting command to the broadcasting device 25 via the wireless network 20 (step S423). Then, the broadcasting device 25 receives the broadcasting command transferred from the wireless access point 23 via the wireless network 20 (step S425).

In the first stage I and the second stage II, the broadcasting system of the invention authenticates the source device 27 and the broadcasting device 25 through the existing architecture of wireless network 20. In the third stage III, a direct communication link is created between the source device 27 and the broadcasting device 25, and the multimedia bitstream is wirelessly transmitted via the direct communication link.

The third stage III can be further divided into the following steps:

The broadcasting device 25 transmits a request for creating direct communication link to the wireless access point 23 via the wireless network 20 (step S431). The wireless access point 23 further transmits the request for creating direct communication link to the source device 27 via the wireless network 20 (step S433). The source device 27 creates a direct communication link with the broadcasting device 25 (step S435).

After the direct communication link is created, the communication between the source device 27 and the broadcasting device 25 does not have to be conducted via the wireless access point 23 and the wireless network 20. After that, the source device 27 transmits the multimedia bitstream to the broadcasting device via the direct communication link 25 (step S437).

In the fourth stage IV, after the broadcasting device 25 receives a multimedia bitstream via the direct communication link (step S441), the broadcasting device 25 stores and/or broadcasts the multimedia bitstream (step S443).

The time at which the multimedia bitstream is broadcast by the broadcasting device 25 can be changed according to the user's needs or the application of the system.

For example, the broadcasting device 25 can broadcast the multimedia bitstream at the same time when receiving a multimedia bitstream via the direct communication link. Or, the broadcasting device 25 can complete the operation of receiving the multimedia bitstream first, and then broadcast the contents of the multimedia bitstream at some other time.

According to the former exemplification disclosed above, the broadcasting storage module 257 provides a buffer space for storing the contents of the multimedia bitstream which are broadcast latter on. While the multimedia bitstream is being broadcast, new contents of the multimedia bitstream can be simultaneously received and stored to the buffer space.

According to the latter exemplification disclosed above, the broadcasting device 25 stores a particular multimedia bitstream to a non-volatile memory having larger capacity (such as hard disc or solid-state disk) first, and then broadcasts the multimedia bitstream at another time. For example, the user A uses his/her notebook computer to transmit the contents of a film to a display at home. Then, the family member B can view the film even when notebook computer is taken out by the user A.

According to the above descriptions, the multimedia bitstream broadcasting system of the invention separates the control process and the transmission process between the source device and the broadcasting device, such that the method occupying wider bandwidth of wireless network can be improved.

In practical application, the source device will generate a broadcasting command in response to the trigger signal for transmitting the multimedia bitstream to the broadcasting device. The process of activating the multimedia bitstream is relatively simple, largely increasing the transmission efficiency of multimedia bitstream.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multimedia bitstream broadcasting system, comprising:
a wireless access point, for providing a wireless network;
a broadcasting device, in communication with the wireless network; and,
a source device, in communication with the wireless network, for providing a multimedia bitstream, wherein the source device generates a broadcasting command according to a trigger signal, a direct communication link is created between the source device and the broadcasting device after the broadcasting command is transmitted to the broadcasting device via the wireless network, and the multimedia bitstream is transmitted to the broadcasting device by the source device via the direct communication link.

2. The broadcasting system according to claim 1, wherein the wireless access point confirms that the broadcasting device and the source device have the right to access the wireless network after identifying the broadcasting device and the source device respectively.

3. The broadcasting system according to claim 1, wherein the direct communication link is based on a tunneled direct link setup, a Bluetooth communication, or an infrared communication.

4. The broadcasting system according to claim 1, wherein after receiving the multimedia bitstream via the direct communication link, the broadcasting device further stores and broadcasts the multimedia bitstream.

5. The broadcasting system according to claim 1, wherein the source device generates a warning message when the source device cannot create the direct communication link, or when the multimedia bitstream cannot be completely transmitted to the broadcasting device.

6. The broadcasting system according to claim 1, wherein after receiving the broadcasting command, the broadcasting device transmits a request for creating direct communication link to the source device via the wireless network.

7. The broadcasting system according to claim 1, wherein the source device comprises:
a source storage module, for providing a multimedia bitstream;
a trigger module, for generating the trigger signal according to the request for broadcasting the multimedia bitstream;
a source controller, electrically connected to the source storage module and the trigger module, for generating the broadcasting command according to the trigger signal;
a first wireless network module, electrically connected to the source controller and in communication with the wireless access point via the wireless network, for transmitting the broadcasting command to the broadcasting device via the wireless network, and receiving the request for creating direct communication link transmitted from the broadcasting device via the wireless network; and,
a first direct communication module, electrically connected to the source controller, wherein after receiving the request for creating direct communication link, the first wireless network module creates the direct communication link with the broadcasting device, and transmits the multimedia bitstream to the broadcasting device according to the control of the source controller.

8. The broadcasting system according to claim 7, wherein the trigger module generates the trigger signal with a hardware element or a software setting.

9. The broadcasting system according to claim 1, wherein the broadcasting device comprises:
a second wireless network module, in communication with the wireless access point via the wireless network, for receiving the broadcasting command;
a broadcasting controller, electrically connected to the second wireless network module, wherein after receiving the broadcasting command, the second wireless network module transmits the request for creating direct communication link according to the control of the broadcasting controller;
a second direct communication module, electrically connected to the broadcasting controller, for creating the direct communication link with the source device and receiving the multimedia bitstream according to the control of the broadcasting controller; and,
a broadcasting module, electrically connected to the broadcasting controller, for broadcasting the multimedia bitstream according to the control of the broadcasting controller.

10. The broadcasting system according to claim 1, wherein the multimedia bitstream is a video bitstream or an audio bitstream.

11. A multimedia bitstream broadcasting method used between a wireless access point, a broadcasting device and a source device, wherein the broadcasting method comprises the steps of:
providing a wireless network by the wireless access point;
providing a multimedia bitstream by the source device;
generating a broadcasting command by the source device according to a trigger signal;
transmitting the broadcasting command to the broadcasting device via the wireless network by the source device;
creating a direct communication link between the source device and the broadcasting device; and,
transmitting the multimedia bitstream to the broadcasting device via the direct communication link by the source device.

12. The broadcasting method according to claim 11, further comprising the step of:
confirming that the broadcasting device and the source device have the right to access the wireless network after the broadcasting device and the source device are identified by the wireless access point respectively.

13. The broadcasting method according to claim 11, wherein the trigger signal is generated by the source device with a hardware element or a software setting according to the request for broadcasting a multimedia bitstream.

14. The broadcasting method according to claim 11, wherein the direct communication link is based on a tunneled direct link setup, a Bluetooth communication, or an infrared communication.

15. The broadcasting method according to claim 11, further comprising the steps of:
receiving the multimedia bitstream via the direct communication link by the broadcasting device; and
storing and broadcasting the multimedia bitstream by the broadcasting device.

16. The broadcasting method according to claim 11, further comprising the step of:
generating a warning message by the source device when the direct communication link cannot be created, or when the multimedia bitstream cannot be completely transmitted to the broadcasting device.

17. The broadcasting method according to claim 11, further comprising the steps of:
transmitting the request for creating direct communication link to the wireless access point by the broadcasting device after the broadcasting device receives the broadcasting command; and;
transmitting the request for creating direct communication link to the source device by the wireless access point.

18. The broadcasting method according to claim 11, wherein the multimedia bitstream is a video bitstream or an audio bitstream.
